(19) United States
(12) Patent Application Publication
(10) Pub. No.: US 2025/0286863 A1
(43) Pub. Date: Sep. 11, 2025

(54) SECURE REMOTE ACCESS NETWORK TUNNELING

(71) Applicant: BeyondTrust Corporation, Johns Creek, GA (US)

(72) Inventors: Nicholas Sawn Twerdochlib, Johns Creek, GA (US); David William Durham, Johns Creek, GA (US)

(21) Appl. No.: 19/068,455

(22) Filed: Mar. 3, 2025

Related U.S. Application Data
(60) Provisional application No. 63/561,563, filed on Mar. 5, 2024.

(51) Int. Cl. H04L 9/40

(52) U.S. Cl. CPC H04L 63/029; H04L 63/0236; H04L 63/0428

(57) ABSTRACT

Disclosed are systems and processes for remote network tunneling. A processor within the system is operatively configured to receive a network tunnel request routed from a user computing device to an intermediary target computing device through a network appliance computing device. The processor initiates a tunnel process at the intermediary target computing device. Initiating the tunnel process includes generating a network tunnel operatively connecting the user computing device and the intermediary target computing device according to one or more parameters included in the network tunnel request. The processor receives transmission data including a data packet from the user computing device via the network tunnel. A transmission data subset including network traffic data is encapsulated as a payload of the data packet. The data packet and the transmission data subset correspond to different layers in a network model stack. The network traffic data is injected into a remote network.

### CROSS-REFERENCE TO RELATED APPLICATIONS

This application is a Non-Provisional Patent Application of, and claims the benefit of and priority to, U.S. Provisional Patent Application No. 63/561,563, filed on Mar. 5, 2024, and entitled “SECURE REMOTE ACCESS NETWORK TUNNELING,” the disclosure of which is incorporated by reference as if the same were fully set forth herein.

### TECHNICAL FIELD

The present systems and processes relate generally to computer networks, and more specifically to network and protocol tunneling.

### BACKGROUND

Remote networks are becoming increasingly prevalent which, as a result, has created a need for remote network management and security solutions. Conventional remote network management solutions include remote access protocols such as Remote Desktop Protocol (RDP), Secure Shell (SSH), and other similar protocols. However, there is a need for heightened credentialing and permissions management to control which networks and nodes can be accessed by users using these conventional remote access protocols. Moreover, remote networks are typically protected by one or more firewalls, which can be problematic for remote access processes given the protocols, internet protocol (IP) addresses, and/or port numbers, etc., used for the remote access processes are likely to be blocked by the firewalls. Firewalls can be configured, or opened, to allow certain types of network traffic based on the traffic characteristics or various permission levels of the traffic sender or recipient; however, doing so creates vulnerabilities in the networks which the firewalls are intended to protect. Therefore, there exists a long-felt but unmet need for secure remote access network tunneling.

### BRIEF SUMMARY OF DISCLOSURE

Briefly described, and according to one embodiment, aspects of the present disclosure generally relate to secure and remote access to computer networks. More specifically, embodiments of the present disclosure relate to network and protocol tunneling.

In at least one example, an example network tunneling system is disclosed. The example network tunneling system generally allows for lower level network traffic data (such as layer three data of the Open Systems Interconnection (OSI) model) to be encapsulated at a representative or client/user system as the data payload of a higher level data packet. The encapsulated network traffic data can then be transmitted over a specifically configured network tunnel to a particular node with access to a remote network. Further, in response to the particular node receiving the higher level data packet, the node can be operatively configured to unwrap the higher level data packet such that the lower level network traffic data can be extracted/obtained from the higher level transmission. Accordingly, the particular node can inject, or route, the lower level network traffic into the remote network as if the representative system had transmitted the network traffic to the remote network directly as lower level network traffic.

The systems and processes disclosed herein provide multiple technical solutions over conventional systems. First, by encapsulating or wrapping lower level network traffic into a higher level network traffic packet (such as a Transmission Control Protocol (TCP) packet), the system can analyze network permissions at both the higher and lower OSI data levels. Second, the disclosed systems and processes simplify the connection process between the representative system and the device, node, service, or general network item on the remote network to which a user at the representative system is seeking access. In particular, by wrapping the lower level data into a higher level data packet and transmitting the higher level data packet over a tunneled Transport Layer Security (TLS) connection, the two connected items need only connect back to a central appliance over an outbound port (e.g., port 443, port 80, or the like) regardless of the port and IP address configurations corresponding to the lower level data.

Consider an example scenario in which a user at the representative system seeks to gain remote access to a device on a remote network using the remote desktop protocol (RDP); however, multiple firewalls exist between the representative system and the remote network which may block traffic to and from the IP addresses and ports (such as port 3389) which allow RDP transmissions. By wrapping the lower level RDP data into a higher level data packet payload and transmitting that data packet over the TLS-connected tunnel via a configurable outbound port (e.g., port 443), the higher level data packet can be received at an intermediary target computing device/destination (a server connected to the current network) given firewalls generally allow network traffic via port 443. In response to being received at the intermediary target computing device (also referred to throughout the present disclosure as a Jumpoint machine) which generally has access to the device/item on the remote network to which the user is seeking access (either directly or via a local network device), the lower level network traffic can be unwrapped at the target destination and furthermore injected into the remote network as if the lower level traffic was transmitted to the remote network (or a device local to the remote network) directly. The intermediary target destination can unpack the intended message. The intermediary target destination can verify whether the sender is allowed to perform a remote desktop connection based on metadata included in the lower level RDP data and/or the higher level data packet. If allowed, the intermediary target destination can transmit the RDP data to another server located on the remote network. The other server can inject the RDP data onto the remote network. In some embodiments, the intermediary target destination can bridge the connection to the remote network. The intermediary target destination can directly inject the RDP data onto the remote network. If permissions are configured to allow remote desktop connections between the two devices, the representative system can establish a remote desktop connection with the device on the remote network via a network tunnel.

Accordingly, given the lower level data can be transmitted as a payload in a TCP stream over TLS via outbound port 443, firewalls between the representative system, the Jumpoint machine, and the remote network need not be opened for specific use case scenarios (such as allowing communications over port 3389 from the user at the representative system), which enhances overall network security. Furthermore, if the firewalls are opened to allow for this traffic, user-level permissions would not otherwise be usable to control whether the connection is allowed.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a diagram illustrating an example network tunneling system architecture, according to one aspect of the present disclosure;

FIG. 2 is a sequence diagram illustrating an example tunnel setup process, according to one aspect of the present disclosure; and

FIG. 3 is a sequence diagram illustrating an example tunnel trafficking process, according to one aspect of the present disclosure.

### DETAILED DESCRIPTION

The disclosed technology generally relates to systems, methods, and apparatuses for network and protocol tunneling in remote networks. Some examples of the disclosed technology will be described more fully with reference to the accompanying drawings. However, this disclosed technology may be embodied in many different forms and should not be construed as limited to the implementations set forth herein. The components described hereinafter as making up various elements of the disclosed technology are intended to be illustrative and not restrictive. Indeed, it is to be understood that other examples are contemplated. Many suitable components that would perform the same or similar functions as components described herein are intended to be embraced within the scope of the disclosed electronic devices and methods. Such other components not described herein may include, but are not limited to, for example, components developed after development of the disclosed technology.

Throughout this disclosure, various aspects of the disclosed technology can be presented in a range of formats (e.g., a range of values). It should be understood that such descriptions are merely for convenience and brevity and should not be construed as an inflexible limitation on the scope of the disclosed technology. Accordingly, the description of a range should be considered to have specifically disclosed all the possible subranges as well as individual rational numerical values within that range. For example, a range described as being “from 1 to 6” or “from approximately 1 to approximately 6” includes the values 1, 6, and all values therebetween. Likewise, a range described as being “between 1 and 6” or “between approximately 1 and approximately 6” includes the values 1, 6, and all values therebetween. The same premise applies to any other language describing a range of values. That is to say, the ranges disclosed herein are inclusive of the respective endpoints, unless otherwise indicated.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

In the following description, numerous specific details are set forth. But it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicates that different instances of like objects are being referred to and are not intended to imply that the objects so described should be in a given sequence, either temporally, spatially, in ranking, or in any other manner.

Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

For the purpose of promoting an understanding of the principles of the present disclosure, reference will now be made to the illustrative examples provided in the drawings, and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims. All limitations of scope should be determined in accordance with and as expressed in the claims.

### Overview

Briefly described, and according to one embodiment, aspects of the present disclosure generally relate to secure and remote access to computer networks. More specifically, embodiments of the present disclosure relate to network and protocol tunneling.

In at least one example, an example network tunneling system is disclosed. The example network tunneling system generally allows for lower level network traffic data (such as layer three data of the Open Systems Interconnection (OSI) model) to be encapsulated at a representative or client/user system as the data payload of a higher level data packet. The encapsulated network traffic data can then be transmitted over a specifically configured network tunnel to a particular node with access to a remote network. Further, in response to the particular node receiving the higher level data packet, the node can be operatively configured to unwrap the higher level data packet such that the lower level network traffic data can be extracted/obtained from the higher level transmission. Accordingly, the particular node can inject, or route, the lower level network traffic into the remote network as if the representative system had transmitted the network traffic to the remote network directly as lower level network traffic.

The systems and processes disclosed herein provide multiple technical solutions over conventional systems. First, by encapsulating or wrapping lower level network traffic into a higher level network traffic packet (such as a Transmission Control Protocol (TCP) packet), the system can analyze network permissions at both the higher and lower OSI data levels. Second, the disclosed systems and processes simplify the connection process between the representative system and the device, node, service, or general network item on the remote network to which a user at the representative system is seeking access. In particular, by wrapping the lower level data into a higher level data packet and transmitting the higher level data packet over a tunneled Transport Layer Security (TLS) connection, the two connected items need only connect back to a central appliance over an outbound port (e.g., port 443, port 80, or the like) regardless of the port and IP address configurations corresponding to the lower level data.

Consider an example scenario in which a user at the representative system seeks to gain remote access to a device on a remote network using the remote desktop protocol (RDP); however, multiple firewalls exist between the representative system and the remote network which may block traffic to and from the IP addresses and ports (such as port 3389) which allow RDP transmissions. By wrapping the lower level RDP data into a higher level data packet payload and transmitting that data packet over the TLS-connected tunnel via a configurable outbound port (e.g., port 443), the higher level data packet can be received at an intermediary target computing device/destination (a server connected to the current network) given firewalls generally allow network traffic via port 443. In response to being received at the intermediary target destination (also referred to throughout the present disclosure as a Jumpoint machine) which generally has access to the device/item on the remote network to which the user is seeking access (either directly or via a local network device), the lower level network traffic can be unwrapped at the target destination and furthermore injected into the remote network as if the lower level traffic was transmitted to the remote network (or a device local to the remote network) directly. The intermediary target destination can unpack the intended message. The intermediary target destination can verify whether the sender is allowed to perform a remote desktop connection based on metadata included in the lower level RDP data and/or the higher level data packet. If allowed, the intermediary target destination can transmit the RDP data to another server located on the remote network. The other server can inject the RDP data onto the remote network. In some embodiments, the intermediary target destination can bridge the connection to the remote network. The intermediary target destination can directly inject the RDP data onto the remote network. If permissions are configured to allow remote desktop connections between the two devices, the representative system can establish a remote desktop connection with the device on the remote network via a network tunnel.

Accordingly, given the lower level data can be transmitted as a payload in a TCP stream over TLS via outbound port 443, firewalls between the representative system, the Jumpoint machine, and the remote network need not be opened for specific use case scenarios (such as allowing communications over port 3389 from the user at the representative system), which enhances overall network security. Furthermore, if the firewalls are opened to allow for this traffic, user-level permissions would not otherwise be usable to control whether the connection is allowed.

### Example Embodiments

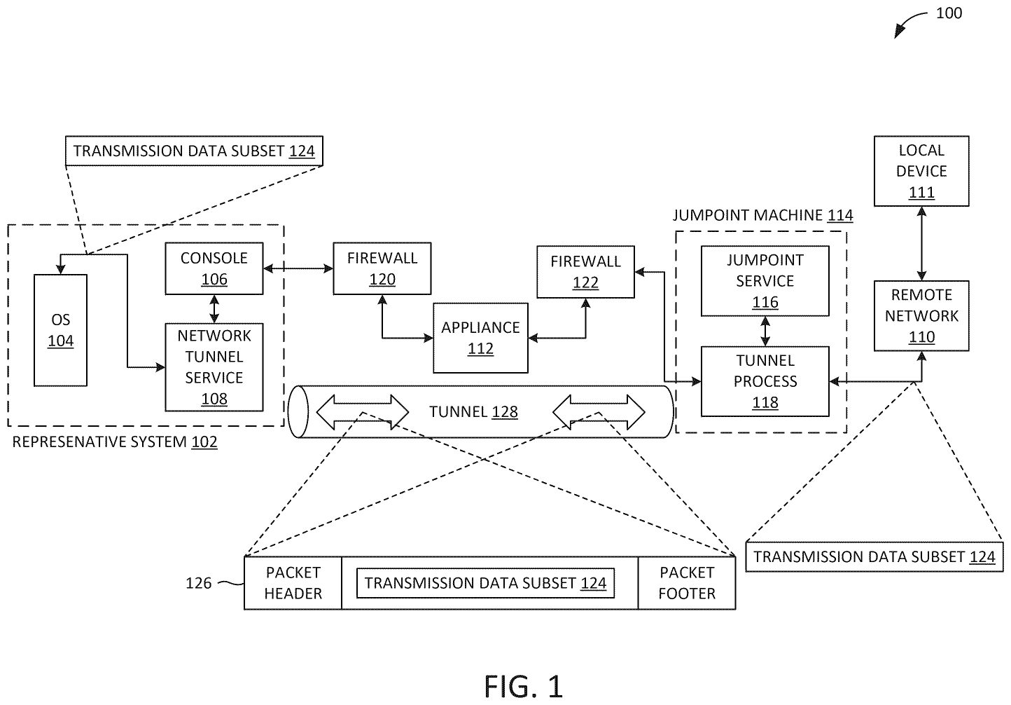

Referring now to the figures, for the purposes of example and explanation of the fundamental processes and components of the disclosed systems and processes, reference is made to FIG. 1, which is a diagram illustrating an example network tunneling system 100, according to one aspect of the present disclosure. As shown in the illustrated example, the network tunneling system 100 can include a representative system 102 (also referred to herein as a “user system” or “user computing device”), which can be an administrator system, network, electronic computing device, or the like. The representative system 102 can include an operating system 104 (OS 104), as well as a remote access console 106 (console 106) and a network tunnel service 108. In one example, the remote access console 106 can be a client application running on the representative system 102. The console 106 can include a graphical user interface (GUI) through which a user at the representative system 102 can configure a network tunnel 128. In certain examples, a user at the representative system 102 can configure the network tunnel service 108 via the console 106. In one example, and as will be discussed in greater detail herein, the network tunnel service 108 is an application running on the representative system 102. The network tunnel service 108 can be a software-defined network interface configured to handle communications from the representative system 102 through the network tunnel 128. The network tunnel service 108 can be operatively configured to monitor, identify, and/or filter network traffic within the representative system 102.

As will be discussed in greater detail herein, the representative system 102, through the OS 104, console 106, and the network tunnel service 108, can securely transmit OSI layer three network traffic data wrapped as higher level data to another machine over a network tunnel 128. In one example, the representative system 102 can transmit the wrapped network traffic data to another machine to be injected into a remote network 110. In one example, the other machine mentioned immediately above is also referred to herein as a Jumpoint machine 114, or an intermediary computing device 114.

In one example, the Jumpoint machine 114 can be a computing device, system, and/or service, for facilitating remote access to other computing devices, systems, services, or general computing items. The Jumpoint machine 114 can be a single computing node that provides remote access to multiple systems on a network. Accordingly, and as will be discussed in greater detail herein, the representative system 102 can establish a network tunnel 128 connection with the Jumpoint machine 114. The representative system 102 can route network traffic data to the Jumpoint machine 114 through the tunnel 128. In one example, the Jumpoint machine 114 can forward the network traffic data to an intended recipient device, system, or service, on the remote network 110. In some embodiments, the Jumpoint machine 114 can transmit a message including the network traffic data to a device on the remote network 110, such as a local device 111. The local device 111 can receive the message, extract the network traffic data, and transmit or inject the network traffic data onto the remote network 110.

In at least one example, the local device 111 can receive network traffic intended for the representative system 102, and transmit the traffic to the Jumpoint machine 114. The Jumpoint machine 114 can send the network traffic intended for the representative system 102 to the representative system 102 via the tunnel 128. Moreover, it should be understood by one of ordinary skill in the art that layer three network traffic data generally relates to network traffic data in accordance with the third level of the OSI model. However, despite the discussion of layer three traffic herein, the disclosure is not intended to be limited to layer three network traffic. Rather, the systems and processes disclosed herein can support various levels of network data and traffic.

In one example, a network appliance 112 (also referred to herein as an appliance 112, or a network appliance computing device 112) is operatively connected to both the representative system 102 and the Jumpoint machine 114. In particular, the appliance 112 is operatively configured to facilitate the establishment of the network tunnel 128 through which the representative system 102 and the Jumpoint machine 114 transmit network traffic. The appliance 112 can be a physical hardware network appliance, such as the B Series appliance (or another appropriate appliance solution) manufactured and sold by BeyondTrust Corporation. In other examples, the appliance 112 can be a virtual appliance operating in a cloud-computing environment.

For purposes of example, consider a scenario in which a user at the representative system 102 seeks to remotely access a computing device, network, system, service, item, or the like, in the remote network 110. In this example scenario, the user can provide his/her credentials to the remote access console 106, which can be a software service installed within the representative system 102 or accessible via a web browser. Based on the user's credentials, the console 106 may determine the scope of the user's remote access authority. In one example, the console 106 can be operatively connected to the appliance 112, which can furthermore determine which remote items (in one or more remote networks) the user can access based on his/her role and general permissions.

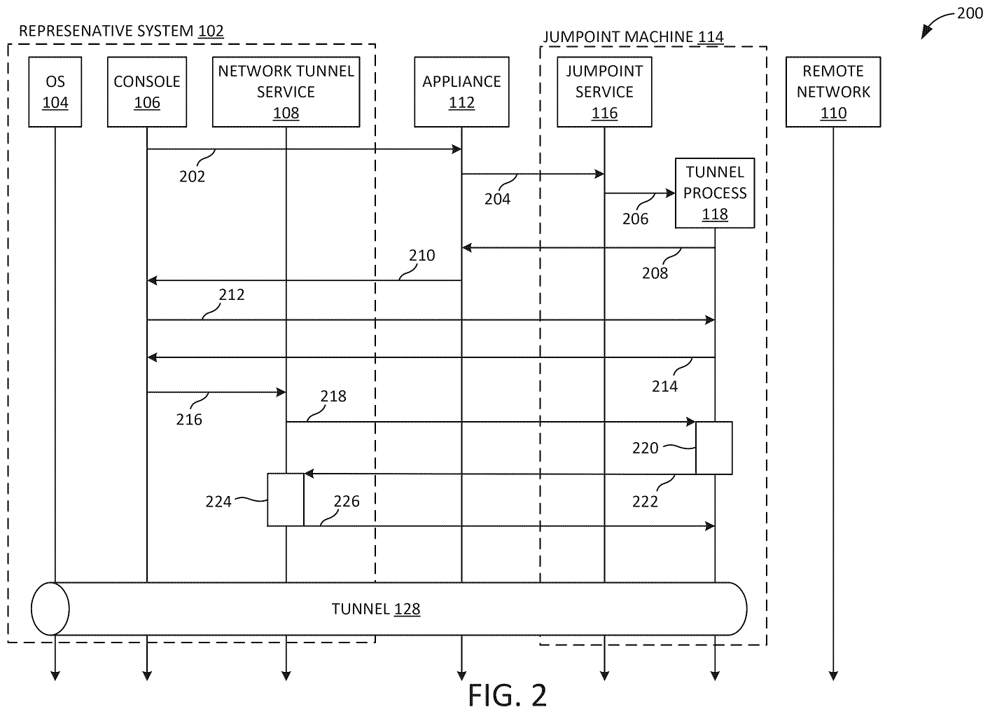

In response to identifying a particular item to access, the user can request that a secure tunnel be established for routing traffic from the representative system to a Jumpoint machine 114 with access to the remote network 110 on which the particular item is located. In one example, the request for establishing a secure tunnel can be transmitted from the console 106 to the appliance 112. The appliance 112 can forward the request to a Jumpoint service 116 (at the Jumpoint machine 114). In one example, the Jumpoint service 116 can spawn, initiate, or instantiate, a specific tunnel process 118 for handling the network tunnel traffic. The tunnel process 118 can return a confirmation message to the console 106 via the appliance 112, which informs the console 106 that a connection with the tunnel process 118 has been established. In one example, the user at the representative system 102 can determine specific configurations for the tunnel 128 to be established between the representative system 102 and the tunnel process 118 at the Jumpoint machine 114. For example, the user can determine which protocols, IP address, ports, etc., the tunnel 128 can allow or support. The user can also determine which users, groups, specific devices, applications, etc., are allowed to transmit traffic via the tunnel 128. The tunnel establishment process is described in greater detail below in connection with the discussion of FIG. 2.

In response to establishing a tunnel 128 between the representative system 102 and the Jumpoint machine 114 (more specifically the spawned tunnel process 118 at the Jumpoint machine 114), lower level network traffic can be wrapped as higher level network traffic. In one example, the wrapped network traffic can be securely transmitted to the Jumpoint machine 114 over the tunnel 128 via a TSL-encrypted TCP stream. For example, and based on the tunnel 128 configurations as determined by the user or another administrator at the representative system 102, the network tunnel service 108 at the representative system 102 can be operatively configured to detect/intercept OSI layer three network data transmitted (or generated) by the OS 104. In one example, the network tunnel service 108 can be operatively configured to include (or operate as) a virtual network interface card/controller (NIC). In one example, the NIC can be a software-defined network interface for detecting or intercepting certain network traffic of interest in accordance with the tunnel 128 configurations. The detected or intercepted network traffic of interest is illustrated in FIG. 1 as transmission data subset 124. While the present disclosure refers to the transmission data subset 124 as layer three data or layer seven through layer three data, it can be appreciated that this data may be formed in a variety of protocol formats and does not necessarily include the formatting of layer seven through layer three data of the OSI model stack.

In certain examples, the intercepted network traffic can be data such as remote desktop protocol (RDP) data, virtual network computing (VNC) data, Secure Shell Protocol (SSH) data, Telnet data, Web Jump data, protocol tunneling data, or any similar layer three data or the like. In some embodiments, the transmission data subset 124 can correspond to Extensible Markup Language (XML) data or another protocol format with fields for various data elements used to form one or more layers of an OSI model transmission. Moreover, the intercepted data can include destination information (such as port(s) and IP addresses) corresponding to a particular computing device on the remote network 110, such as the local device 111.

The network tunnel service 108 can forward the intercepted layer three traffic of interest to the console 106. In one example, the console 106 can be operatively configured to encapsulate, or wrap, the layer three traffic of interest into a higher level data packet such as a TCP packet. In certain examples, the console 106 can wrap the layer three data into a proprietary routing protocol. In one example, and as illustrated in FIG. 1 as the data packet 126, the transmission data subset 124 (e.g., including data from layer seven down to layer three) can be encapsulated as the data payload of a higher level data packet (e.g., which can include data from layer seven down to layer one). In one example, the data packet 126 can be transmitted via TLS through outbound port 443 over the tunnel 128 to the tunnel process 118 running on the Jumpoint machine 114. In response to receiving the data packet 126, the tunnel process 118 can unwrap the data packet 126 and extract the transmission data subset 124 that was encapsulated therein.

The tunnel process 118 can perform a permissions analysis on the data packet 126. The tunnel process 118 can identify metadata corresponding to the data packet 126 and transmission data subset 124, which can be used for a permissions analysis. Performing a permissions analysis on the data packet 126 is technically advantageous given the data packet 126 includes higher level data (for example, data from OSI layer seven through layer one). Accordingly, the tunnel process 118 can analyze permissions not only for the sender and recipient at each end of the tunnel 128 (according to the metadata in the higher level data in the data packet 126), but also for the specific user at the representative system 102, the OS 104, and the intended computing device/item within the remote network 110 (according to the transmission data subset 124 encapsulated within the data packet 126 and metadata corresponding to the same). For example, the tunnel process 118 can determine if a user account of the sender is allowed to send packets to a user account of the receiver. Further, the tunnel process 118 can evaluate other rules, such as one or more of: 1) whether the user account is authorized on the representative system 102, whether the communication type is authorized, whether protocols used in the transmission data subset are authorized, whether the representative system 102 is within one or more geofences, or another rule. Furthermore, the tunnel process 118 can be configured to include a virtual network driver interface specification (NDIS) filter, which can allow for the tunnel process 118 at the Jumpoint machine 114 to further filter the incoming (and outgoing) network traffic according to the tunnel configurations and established permissions.

Multiple firewalls (such as the firewall 120 and firewall 122) can exist between the representative system 102 and the remote network 110. The firewall 120 and firewall 122 can be operatively configured to block certain types of network traffic to and from the representative system 102 and the remote network 110. For example, consider a scenario in which the user at the representative system 102 seeks to send RDP traffic to the remote network 110; however, both firewalls 120 and 122 are configured to block traffic to and from the IP addresses and ports (such as port 3389) which enable RDP transmissions. By wrapping the lower level RDP data into a higher level data packet payload and transmitting that data packet over the tunnel 128 via outbound port 443, the higher level data packet can be received at the Jumpoint tunnel process 118 given firewalls generally allow traffic via port 443. In response to being received at the Jumpoint tunnel process 118, the lower level RDP data can be unwrapped from the higher level data packet and can be injected into the remote network 110 as if the RDP traffic was transmitted to the remote network 110 directly.

Turning now to FIG. 2, a sequence diagram is shown illustrating an example tunnel setup process 200, according to one aspect of the present disclosure. In one example, the tunnel setup process 200 includes the “handshaking” process by which devices, servers, processes, and services on or between networks agree upon the terms of future communications to take place over an established network connection. According to various aspects of the present disclosure, the tunnel setup process 200 represents the steps by which a network tunnel 128 is established between the representative system 102 and the Jumpoint machine 114.

In one example, the process 200 can begin at step 202, where a user can log into the console 106 (such as a privileged remote access console) and generate a request for establishing a new tunnel. Generating a request for establishing a tunnel can include determining permissions and access parameters for the tunnel. In one example, permissions and access parameters for the tunnel can include parameters such as which users or groups within an organization can access the tunnel, which protocols can be transmitted over the tunnel, specific port and IP numbers accessible via the tunnel, which applications or data types can be transmitted over the tunnel, for how long the tunnel should be active, etc. In particular, at step 202, the console 106 can establish a connection to the appliance 112 over a TCP socket on port 443, over which the request for a new tunnel is transmitted. Further, the console 106 connecting to the appliance 112 over a TCP socket on port 443 establishes the console's routing information with the appliance 112. In one example, the console's routing information can include routing information for a particular secure remote access protocol. In one example, at step 202, the appliance 112 can receive the console's routing protocol information. Moreover, in response to receiving the request for a new tunnel as transmitted by the console 106, the appliance 112 can perform an authentication process to determine whether the corresponding user at the console 106 has appropriate credentials for requesting a new tunnel. In some examples, the appliance 112 can delegate the authentication process to a third-party service, such as an external identity provider (e.g., via Security Assertion Markup Language (SAML), Lightweight Directory Access Protocol (LDAP), etc.).

In response to receiving a request for establishing a new tunnel, the appliance 112 determines, based on the user's roles, permissions, and general authority within the representative system 102, which Jumpoints (or Jump Items) the user may have authorization to access. In particular examples, a Jumpoint is a client type that can be installed on a remote network and can facilitate certain types of connections, such as RDP, Virtual Network Computing (VNC), Secure Shell (SSH) or Telnet, Web Jump, protocol tunneling, etc. In one example, a Jump Item can be a particular computer or machine on the Jumpoint's network that is accessible via the Jumpoint. In one example, the local device 111 can be a Jump Item. The appliance 112 can then return a list including available Jumpoints and/or Jump Items to the console 106 for configuring the tunnel.

In response to the user selecting (via the console 106) one or more particular Jump Items to access, the user can request for the tunnel to be established. In one example, the request can be routed to the appliance 112. The appliance 112 can perform an additional authentication process for determining whether the user has authority to establish the tunnel as configured. If the user's access rights are authenticated, the appliance 112 can transmit the request for establishing a tunnel to the Jumpoint machine 114.

In particular, at step 204, the appliance 112 can transmit the request for establishing a tunnel to a Jumpoint service 116. In one example, the Jumpoint service 116 can can be a software service installed and running on the Jumpoint machine 114. The request for establishing a network tunnel, as transmitted by the appliance 112 at step 204, can include the tunnel information as configured by the user at the console 106. In one example, the request for establishing a tunnel also includes instructions for the Jumpoint service 116 to establish the network tunnel as configured by the user at the console 106.

At step 206, and in response to receiving the request for establishing the network tunnel, the Jumpoint service 116 can initiate, or “spawn,” the tunnel process 118. In one example, and in response to the Jumpoint service 116 receiving the request for establishing a new tunnel, the Jumpoint service 116 spawns an independent process for handing the network tunnel request.

At step 206, the Jumpoint Service 116 can transmit the tunnel configuration information to the newly-spawned tunnel process 118. Accordingly, in response to spawning the tunnel process 118 and transmitting the tunnel configuration information to the tunnel process 118, the independent tunnel process 118 can be operatively configured to handle all subsequent tunnel operations within the Jumpoint machine 114. In response to the initiating the tunnel process 118, the tunnel process 118 generates its own unique protocol routing address for internal routing.

Proceeding now to step 208, the tunnel process 118 transmits its unique protocol routing address/information to the appliance 112 for establishing an internal route back to the tunnel process 118. Accordingly, the appliance 112 records the unique protocol routing addresses and information for both the tunnel process 118 and the console 106. In one example, the appliance 112 can maintain an internal routing table in which it stores the routing information for both the console 106 and the tunnel process 118.

In response to the tunnel process 118 transmitting its unique protocol routing address to the appliance 112, the tunnel process 118 is operatively configured to “listen” for a response from the console 106 with its respective unique protocol routing address.

At step 210, the appliance 112 can forward the tunnel process's 118 unique protocol routing address to the console 106. At step 212, and in response to receiving the tunnel process's 118 routing address, the console 106 can establish a connection (according to an agreed upon protocol) with the tunnel process 118 on the Jumpoint machine 114.

At step 214, the tunnel process 118 can accept the protocol connection transmitted by the console 106. In one example, the tunnel process 118 can furthermore transmit back to the console 106 an acknowledgement of having received and accepted the console's protocol connection.

At step 216, a user at the representative system 102 via the console 106 can establish a connection with the network tunnel service 108. At step 218, and through the network tunnel service 108, the user can establish a connection with the tunnel process 118 for configuring the tunnel process 118 to operate as a virtual NDIS filter (step 220). In one example, the virtual NDIS filter can be separate from, but operatively connected to, the tunnel process 118. Configuring the tunnel process 118 can include indicating filtering parameters for network traffic of interest. In one example, at step 222, the tunnel process 118 can transmit data corresponding to its configuration information back to the network tunnel service 108.

At step 224, the network tunnel service 108 can be operatively configured to operate as a virtual network interface controller in accordance with the virtual NDIS filter configuration at the tunnel process 118. In response to receiving and unwrapping the traffic filtering information transmitted by the tunnel process 118, the network tunnel service 108 uses the traffic filtering information to configure the virtual network interface card on the user's representative system 102. In one example, configuring the virtual NIC based on the configuration information from the NDIS filter at the tunnel process 118 allows for the virtual NIC to intercept network traffic as defined in the configuration information transmitted by the tunnel process 118.

At step 226, the network tunnel service 108 transmits to the tunnel process 118 an indication that the user's machine is configured. Accordingly, a tunnel 128 (as configured in the preceding steps of the process 200) is established between the representative system 102 and the tunnel process 118 within the Jumpoint machine 114. The tunnel 128 can be configured to support routing traffic directly between the representative system 102 and the tunnel process 118. The tunnel 128 can be configured in response to establishing the tunnel 128 between the representative system 102 and the tunnel process 118 within the Jumpoint machine 114. For example, the tunnel 128 can be configured such that the network traffic need not be routed through the appliance 112. The console 106 and the tunnel process 118 can establish a direct or peer-to-peer connections. This connection can be established in response to establishing the tunnel 128. Establishing a direct connection between the console 106 and tunnel process 118 can have the technical advantage of decreased latency given the tunnel traffic can travel a shorter distance by not also being routed through the appliance 112.

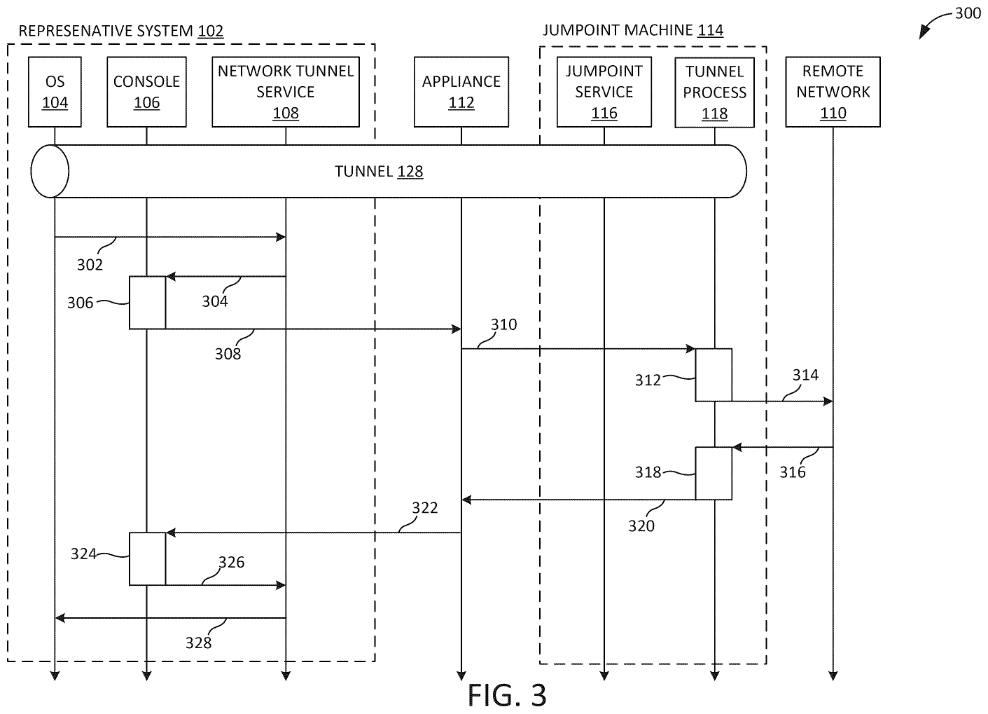

Proceeding to FIG. 3, a sequence diagram is shown illustrating an example tunnel trafficking process 300, according to one aspect of the present disclosure. In one example, the tunnel trafficking process 300 generally relates to the process by which traffic of interest is detected by the representative system 102 (or by a device within the remote network 110) and transmitted through the tunnel 128. Continuing generally with the discussion of the process 200 as described above in connection with FIG. 2, and in response to the handshaking process between the representative system 102 and the Jumpoint machine 114 for establishing the tunnel 128, the process 300 can begin at step 302 where the network tunnel service 108 intercepts traffic of interest from the OS 104. In particular, the virtual NIC at the network tunnel service 108 can be operatively configured to intercept the traffic of interest. In general, traffic of interest can be network traffic which includes one or more characteristics which indicate that the traffic should be routed through the tunnel 128 to the Jumpoint 114. In one example, the intercepted traffic of interest can be OSI layer three data intended to be transmitted from the OS 104 at the representative system 102 to a particular device within the remote network 110.

In response to intercepting the traffic from the OS 104, at step 304 the network tunnel service 108 can forward the intercepted traffic of interest to the console 106 to be routed to the Jumpoint machine 114 through the tunnel 128.

At step 306, and in response to receiving the traffic of interest from the network tunnel service 108, the console 106 can wrap the traffic of interested (generally OSI layer three data) into a higher level data packet (such as a TCP packet or the like). Wrapping the traffic of interest into a higher level packet encapsulates the traffic of interest as the data payload of the higher level packet. The console 106 can route the wrapped traffic of interest to the tunnel process 118 via the appliance 112, which is supported by the TLS connection over the tunnel 128 (steps 308 and 310).

At step 312, the tunnel process 118 can unwrap the tunneled network traffic. Moreover, at step 312, the tunnel process can perform a permissions analysis on the tunneled network traffic before and/or after unwrapping the received tunneled network traffic. In one example, the tunnel process 118 validates the tunneled network traffic against one or more policy rules as configured by the user at the representative system 102 during the tunnel setup process 200 as discussed above in connection with FIG. 2. For example, the tunnel process 118 can apply a policy to determine whether the tunneled network traffic is permitted. The policy can store the configured rules. At step 314, the tunnel process 118 can inject the unwrapped network traffic (the OSI layer three traffic of interest) into the remote network 110.

Receiving incoming OSI layer three network traffic at the representative system 102 from the remote network 110 is generally a reversal of the steps 302-314 discussed above. For example, OSI layer three data transmitted to the tunnel process 118 from the remote network 110 (step 316) can be encapsulated as the payload of a higher level data packet at the tunnel process 118 (step 318) and routed to the console via the appliance 112 (steps 320 and 322). In response to receiving the higher level data packet, the console 106 can unwrap the higher level data packet (step 324) to extract the layer three data wrapped therein. The console 106 can forward the unwrapped layer three data to the network tunnel service 108 (step 326), and can furthermore perform a permissions analysis on the unwrapped layer three data. At step 328, the network tunnel service 108 can inject the layer three data into the local OS network stack at the OS 104.

### Conclusion

The disclosure herein can be carried out wholly or in part by a computing environment, which can include a server computer, or any other system providing computing capability. Alternatively, the computing environment may employ a plurality of computing devices that may be arranged, for example, in one or more server banks or computer banks or other arrangements. Such computing devices can be located in a single installation or may be distributed among many different geographical locations. For example, the computing environment can include a plurality of computing devices that together may include a hosted computing resource, a grid computing resource, and/or any other distributed computing arrangement. In some cases, the computing environment can correspond to an elastic computing resource where the allotted capacity of processing, network, storage, or other computing-related resources may vary over time.

Various applications and/or other functionality may be executed in the computing environment according to various embodiments. Also, various data is stored in a database that is accessible to the computing environment. The database can be representative of a plurality of databases as can be appreciated. The data stored in the database, for example, may be associated with the operation of the various applications and/or functional entities described herein.

The computing environment can communicate with a plurality of computing devices and querying devices (which may include computing devices) via a network. The network includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

It will, nevertheless, be understood that no limitation of the scope of the disclosure is intended by the information disclosed in the figures or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the systems and processes to the precise forms disclosed. Many modifications and variations are possible in light of the above teaching.

The embodiments were chosen and described in order to explain the principles of the systems and processes and their practical application so as to enable others skilled in the art to utilize the systems and processes and various embodiments and with various modifications as are suited to the particular use contemplated. Alternative embodiments will become apparent to those skilled in the art to which the present systems and processes pertain without departing from their spirit and scope. Accordingly, the scope of the present systems and processes is defined by the appended claims rather than the foregoing description and the exemplary embodiments described therein.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a computer to perform one specific function or a group of functions.

Those skilled in the art will understand the features and aspects of a suitable computing environment in which aspects of the disclosure may be implemented. Although not required, some of the embodiments of the claimed systems and processes may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed systems and processes are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems and processes are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the systems and processes is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems and processes will be readily discernible from the description herein, by those of ordinary skill in the art. Many embodiments and adaptations of the disclosure and claimed systems and processes other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems and processes. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems and processes. In addition, some steps may be carried out simultaneously, contemporaneously, or in synchronization with other steps.

Clause 1. A system including: a user computing device; a network appliance computing device operatively connected to the user computing device; and an intermediary target computing device operatively connected to the network appliance computing device, wherein the intermediary target computing device comprises a processor operatively configured to: receive a network tunnel request, wherein the network tunnel request is routed from the user computing device to the intermediary target computing device through the network appliance computing device; initiate a tunnel process at the intermediary target computing device, wherein initiating the tunnel process comprises generating a network tunnel operatively connecting the user computing device and the intermediary target computing device according to one or more parameters included in the network tunnel request; receive transmission data comprising a data packet from the user computing device via the network tunnel, wherein a transmission data subset comprising network traffic data is encapsulated as a payload of the data packet, and wherein the data packet and the transmission data subset correspond to different layers in a network model stack; and inject the network traffic data from the transmission data subset into a remote network.

Clause 2. The system of clause 1 or any other clause herein, wherein prior to injecting the network traffic data into the remote network, the processor is further operatively configured to unwrap the transmission data subset from the payload of the data packet.

Clause 3. The system of clause 1 or any other clause herein, wherein the network traffic data is intended for a particular computing device in the remote network.

Clause 4. The system of clause 3 or any other clause herein, wherein injecting the network traffic data into the remote network comprises forwarding the network traffic data to the particular computing device in the remote network.

Clause 5. The system of clause 1 or any other clause herein, wherein the transmission data subset corresponds to layer three data in an open systems interconnection (OSI) model.

Clause 6. The system of clause 1 or any other clause herein, wherein the data packet corresponds to an abstraction layer above layer three in the OSI model.

Clause 7. The system of clause 1 or any other clause herein, wherein the one or more parameters included in the network tunnel request comprise one or more permissible users, one or more permissible internet protocol (IP) addresses, one or more permissible network ports, and/or one or more permissible network protocols.

Clause 8. A method including: receiving, at an intermediary target computing device operatively connected to a network appliance computing device, a network tunnel request, wherein the network tunnel request is routed from a user computing device to the intermediary target computing device through the network appliance computing device; initiating a tunnel process at the intermediary target computing device, wherein initiating the tunnel process comprises generating a network tunnel operatively connecting the user computing device and the intermediary target computing device according to one or more parameters included in the network tunnel request; receiving transmission data comprising a data packet from the user computing device via the network tunnel, wherein a transmission data subset comprising network traffic data is encapsulated as a payload of the data packet, and wherein the data packet and the transmission data subset correspond to different layers in a network model stack; and injecting the network traffic data from the transmission data subset into a remote network.

Clause 9. The method of clause 8 or any other clause herein, wherein prior to injecting the network traffic data into the remote network, the method includes unwrapping the transmission data subset from the payload of the data packet.

Clause 10. The method of clause 8 or any other clause herein, wherein the network traffic data is intended for a particular computing device in the remote network.

Clause 11. The method of clause 10 or any other clause herein, wherein injecting the network traffic data into the remote network comprises forwarding the network traffic data to the particular computing device in the remote network.

Clause 12. The method of clause 8 or any other clause herein, wherein the transmission data subset corresponds to layer three data in an open systems interconnection (OSI) model.

Clause 13. The method of clause 8 or any other clause herein, wherein the data packet corresponds to an abstraction layer above layer three in the OSI model.

Clause 14. The method of clause 8 or any other clause herein, wherein the one or more parameters included in the network tunnel request comprise one or more permissible users, one or more permissible internet protocol (IP) addresses, one or more permissible network ports, and/or one or more permissible network protocols.

Clause 15. A non-transitory computer readable medium comprising instructions, that when read by a processor, cause the processor to perform: receiving, at an intermediary target computing device operatively connected to a network appliance computing device, a network tunnel request, wherein the network tunnel request is routed from a user computing device to the intermediary target computing device through the network appliance computing device; initiating a tunnel process at the intermediary target computing device, wherein initiating the tunnel process comprises generating a network tunnel operatively connecting the user computing device and the intermediary target computing device according to one or more parameters included in the network tunnel request; receiving transmission data comprising a data packet from the user computing device via the network tunnel, wherein a transmission data subset comprising network traffic data is encapsulated as a payload of the data packet, and wherein the data packet and the transmission data subset correspond to different layers in a network model stack; and injecting the network traffic data from the transmission data subset into a remote network.

Clause 16. The non-transitory computer readable medium of clause 15 or any other clause herein, further comprising instructions that when read by the processor, cause the processor to perform, prior to injecting the network traffic data into the remote network, unwrapping the transmission data subset from the payload of the data packet.

Clause 17. The non-transitory computer readable medium of clause 15 or any other clause herein, wherein the network traffic data is intended for a particular computing device in the remote network.

Clause 18. The non-transitory computer readable medium of clause 17 or any other clause herein, wherein injecting the network traffic data into the remote network comprises forwarding the network traffic data to the particular computing device in the remote network.

Clause 19. The non-transitory computer readable medium of clause 15 or any other clause herein, wherein the transmission data subset corresponds to layer three data in an open systems interconnection (OSI) model, and wherein the data packet corresponds to an abstraction layer above layer three in the OSI model.

Clause 20. The non-transitory computer readable medium of clause 15 or any other clause herein, wherein the one or more parameters included in the network tunnel request comprise one or more permissible users, one or more permissible internet protocol (IP) addresses, one or more permissible network ports, and/or one or more permissible network protocols.

Aspects, features, and benefits of the systems, methods, processes, formulations, apparatuses, and products discussed herein will become apparent from the information disclosed in the figures and the other applications as incorporated by reference. Variations and modifications to the disclosed systems and methods may be effected without departing from the spirit and scope of the novel concepts of the disclosure.

The embodiments were chosen and described in order to explain the principles of the claimed systems and processes and their practical application so as to enable others skilled in the art to utilize the systems and processes and various embodiments and with various modifications as are suited to the particular use contemplated. Alternative embodiments will become apparent to those skilled in the art to which the claimed systems and processes pertain without departing from their spirit and scope. Accordingly, the scope of the claimed systems and processes is defined by the appended claims rather than the foregoing description and the exemplary embodiments described therein.

What is claimed is:

1. A system comprising:
a user computing device;
a network appliance computing device operatively connected to the user computing device; and
an intermediary target computing device operatively connected to the network appliance computing device, wherein the intermediary target computing device comprises a processor operatively configured to:
receive a network tunnel request, wherein the network tunnel request is routed from the user computing device to the intermediary target computing device through the network appliance computing device;
initiate a tunnel process at the intermediary target computing device, wherein initiating the tunnel process comprises generating a network tunnel operatively connecting the user computing device and the intermediary target computing device according to one or more parameters included in the network tunnel request;
receive transmission data comprising a data packet from the user computing device via the network tunnel, wherein a transmission data subset comprising network traffic data is encapsulated as a payload of the data packet, and wherein the data packet and the transmission data subset correspond to different layers in a network model stack; and
inject the network traffic data from the transmission data subset into a remote network.

2. The system of claim 1, wherein prior to injecting the network traffic data into the remote network, the processor is further operatively configured to unwrap the transmission data subset from the payload of the data packet.

3. The system of claim 1, wherein the network traffic data is intended for a particular computing device in the remote network.

4. The system of claim 3, wherein injecting the network traffic data into the remote network comprises forwarding the network traffic data to the particular computing device in the remote network.

5. The system of claim 1, wherein the transmission data subset corresponds to layer three data in an open systems interconnection (OSI) model.

6. The system of claim 1, wherein the data packet corresponds to an abstraction layer above layer three in the OSI model.

7. The system of claim 1, wherein the one or more parameters included in the network tunnel request comprise one or more permissible users, one or more permissible internet protocol (IP) addresses, one or more permissible network ports, and/or one or more permissible network protocols.

8. A method comprising:
receiving, at an intermediary target computing device operatively connected to a network appliance computing device, a network tunnel request, wherein the network tunnel request is routed from a user computing device to the intermediary target computing device through the network appliance computing device;
initiating a tunnel process at the intermediary target computing device, wherein initiating the tunnel process comprises generating a network tunnel operatively connecting the user computing device and the intermediary target computing device according to one or more parameters included in the network tunnel request;
receiving transmission data comprising a data packet from the user computing device via the network tunnel, wherein a transmission data subset comprising network traffic data is encapsulated as a payload of the data packet, and wherein the data packet and the transmission data subset correspond to different layers in a network model stack; and
injecting the network traffic data from the transmission data subset into a remote network.

9. The method of claim 8, further comprising prior to injecting the network traffic data into the remote network, unwrapping the transmission data subset from the payload of the data packet.

10. The method of claim 8, wherein the network traffic data is intended for a particular computing device in the remote network.

11. The method of claim 10, wherein injecting the network traffic data into the remote network comprises forwarding the network traffic data to the particular computing device in the remote network.

12. The method of claim 8, wherein the transmission data subset corresponds to layer three data in an open systems interconnection (OSI) model.

13. The method of claim 8, wherein the data packet corresponds to an abstraction layer above layer three in the OSI model.

14. The method of claim 8, wherein the one or more parameters included in the network tunnel request comprise one or more permissible users, one or more permissible internet protocol (IP) addresses, one or more permissible network ports, and/or one or more permissible network protocols.

15. A non-transitory computer readable medium comprising instructions, that when read by a processor, cause the processor to perform:
receiving, at an intermediary target computing device operatively connected to a network appliance computing device, a network tunnel request, wherein the network tunnel request is routed from a user computing device to the intermediary target computing device through the network appliance computing device;
initiating a tunnel process at the intermediary target computing device, wherein initiating the tunnel process comprises generating a network tunnel operatively connecting the user computing device and the intermediary target computing device according to one or more parameters included in the network tunnel request;
receiving transmission data comprising a data packet from the user computing device via the network tunnel, wherein a transmission data subset comprising network traffic data is encapsulated as a payload of the data packet, and wherein the data packet and the transmission data subset correspond to different layers in a network model stack; and
injecting the network traffic data from the transmission data subset into a remote network.

16. The non-transitory computer readable medium of claim 15, further comprising instructions that when read by the processor, cause the processor to perform, prior to injecting the network traffic data into the remote network, unwrapping the transmission data subset from the payload of the data packet.

17. The non-transitory computer readable medium of claim 15, wherein the network traffic data is intended for a particular computing device in the remote network.

18. The non-transitory computer readable medium of claim 17, wherein injecting the network traffic data into the remote network comprises forwarding the network traffic data to the particular computing device in the remote network.

19. The non-transitory computer readable medium of claim 15, wherein the transmission data subset corresponds to layer three data in an open systems interconnection (OSI) model, and wherein the data packet corresponds to an abstraction layer above layer three in the OSI model.

20. The non-transitory computer readable medium of claim 15, wherein the one or more parameters included in the network tunnel request comprise one or more permissible users, one or more permissible internet protocol (IP) addresses, one or more permissible network ports, and/or one or more permissible network protocols.
